(19) United States
(12) Patent Application Publication
(10) Pub. No.: US 2024/0411481 A1
(43) Pub. Date: Dec. 12, 2024

(54) Universal Flash Storage Shared Write Booster Buffer Enhancements

(71) Applicant: QUALCOMM Incorporated, San Diego, CA (US)

(72) Inventors: Chintalapati BHARATH SAI VARMA, Hyderabad (IN); Santhosh Reddy AKAVARAM, Hyderabad (IN); Sai Naresh GAJAPAKA, Hyderabad (IN); Hung VUONG, Coronado, CA (US); Radhakrishna MUGADA, Hyderabad (IN); Prakhar SRIVASTAVA, Lucknow (IN); Vamsi Krishna SAMBANGI, Vizianagaram (IN)

(21) Appl. No.: 18/530,074

(22) Filed: Dec. 5, 2023

Related U.S. Application Data
(60) Provisional application No. 63/506,372, filed on Jun. 6, 2023.

(51) Int. Cl. G06F 3/06

(52) U.S. Cl. CPC G06F 3/0656; G06F 3/0679; G06F 3/0604

(57) ABSTRACT

Methods that may be performed by a universal flash storage (UFS) system of a computing device for optimizing usage of a shared write booster buffer to extend lifetime. The method may include writing data to a flash storage device including a plurality of logical units of memory by receiving a command identifying a logical unit among the plurality of logical units to store data and data for storage in the identified logical unit, obtaining information indicating a memory write type for the identified logical unit, and writing the received data to either a shared write booster buffer before writing to the identified logical unit of device storage or directly to the identified logical unit of device storage based on the obtained memory write type

### RELATED APPLICATIONS

The present application claims the benefit of priority to U.S. Provisional Application No. 63/506,372, entitled “Universal Flash Storage Write Boost Buffer Enhancements” filed Jun. 6, 2023, the entire contents of which are hereby incorporated by reference for all purposes.

### BACKGROUND

Developers and users of computing devices are always seeking improved operation performance and endurance. The lifetime of NAND flash memories may be physically limited to a certain number of write cycles. In some applications, such as buffers and cache memory elements, quick cycling of data temporarily stored in such memory elements can quickly deteriorate the lifetime of the entire device.

### SUMMARY

Various aspects may further include methods performed by a universal flash storage (UFS) system of a computing device for writing data to a flash storage device including a plurality of logical units of memory. Various aspects may include receiving, by the flash storage device, a command identifying a logical unit among the plurality of logical units to store data and data for storage in the identified logical unit, obtaining information indicating a memory write type for the identified logical unit, and writing the data to either a shared write booster buffer before writing to the identified logical unit of device storage of the identified logical unit or directly to the identified logical unit of device storage of based on the obtained memory write type.

Some aspects may further include storing in a memory table of the flash storage device a value indicating the memory write type for each of the plurality of logical units, in which obtaining information indicating the memory write type for the identified logical unit may include obtaining, from the memory table, the value indicating the memory write type corresponding to the identified logical unit. In some aspects, storing in the memory table of the flash storage device a value indicating the memory write type for each of the plurality of logical units may include provisioning the memory table at boot of the flash storage device. Some aspects may further include receiving by the flash storage device a command that changes the value indicating the memory write type corresponding to one or more of the plurality of logical units.

In some aspects, obtaining information indicating the memory write type for the identified logical unit may include obtaining the information indicating the memory write type from the command identifying the logical unit to store the data. In some aspects, the information in the command indicating the memory write type may include a bit in a command Universal Flash Storage (UFS) Protocol Information Unit (UPIU) in which the bit indicates that subsequent data should be written to the shared write booster buffer before writing to the identified logical unit of device storage identified in the command UPIU or written directly to the identified logical unit of device storage identified in the command UPIU.

Further aspects include a UFS system including a UFS device controller and a host controller configured to perform operations of any of the methods summarized above. Further aspects include a computing device including means for performing functions of any of the methods summarized above. Further aspects include a UFS device controller and a host controller for use in a computing device, the UFS device controller and the host controller each including a processor configured to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a system block diagram illustrating an example memory system suitable for implementing any of the various embodiments.

FIG. 2 is a system block diagram illustrating an example memory system suitable for implementing any of the various embodiments.

FIG. 3 is a component block diagram illustrating an example computing device suitable for implementing any of the various embodiments.

FIG. 4 is a component block diagram illustrating an example system configured for universal flash storage (UFS) buffer usage optimization according to some embodiments.

FIG. 5 is a component block and signaling diagram illustrating an example of UFS read throughput enhancements according to some embodiments.

FIG. 6 is a process flow diagram of an example method for UFS buffer usage optimization in accordance with some embodiments.

FIG. 7A is a process flow diagram of an example method for UFS buffer usage optimization in accordance with some embodiments.

FIG. 7B is a process flow diagram of an example method for UFS buffer usage optimization in accordance with some embodiments.

FIG. 8 is a component block diagram illustrating an example personal computer suitable for use with the various embodiments.

FIG. 9 is a component block diagram illustrating an example server suitable for use with the various embodiments.

FIG. 10 is a component block diagram illustrating an example wireless communication device suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and computing devices for implementing the methods for optimizing the usage and write cycles of a write boost buffer of a flash storage device. Various embodiments may include methods performed by a universal flash storage (UFS) system of a computing device including receiving, by the flash storage device, a command identifying a logical unit among the plurality of logical units to store data and data for storage in the identified logical unit, obtaining information indicating a memory write type for the identified logical unit, and then writing the data to either a shared boost buffer before writing to the identified logical unit of device storage or directly to the identified logical unit of device storage based on the obtained memory write type.

Some embodiments may include storing in a memory table of the flash storage device a value indicating the memory write type for each of the plurality of logical units, in which embodiments the memory write type may be obtained from the memory table. Some embodiments may include receiving by the flash storage device a command that changes the value indicating the memory write type corresponding to one or more of the plurality of logical units.

Some embodiments may include obtaining the memory write type from a command, which is received from a host controller of the computing device, identifying the logical unit in which to store data. In some embodiments the command may be a Universal Flash Storage (UFS) Protocol Information Unit (UPIU), and the information in the UPIU indicating the memory write type may be in the form of a bit or similar value.

More generally, a UFS device may operate as a storage module with a plurality of logical units (LU) and may include a write buffer to increase the speed of data writes to the device (e.g., before placement in normal storage). A majority of the storage volumes may be triple level cell (TLC) NAND memory elements, while some memory, including the write buffer, may be single layer cell (SLC) NAND memory elements.

In SLC NAND memory elements, each memory cell stores only one bit of data, representing either a ‘0’ or a ‘1’. Due to the simplicity of storing a single bit per cell, SLC memory has several advantages, including faster write and read speeds, higher endurance, and lower error rates.

In TLC NAND memory elements, each memory cell stores three bits of data, resulting in eight possible voltage levels. While this increases the storage density, it also introduces a few trade-offs compared to SLC memory, including slower write and read speeds, lower endurance, and higher error rates.

The normal storage of the flash device may be TLC NAND and the flash device (e.g., UFS device) may include a write buffer of SLC NAND memory elements that temporarily stores received data before transferring the data to normal storage in the TLC NAND memory. Repeated cycling of all incoming data through the write boost buffer may deteriorate the endurance of the NAND cells faster than is necessary. This may occur when the UFS device is configured to always write all data to the write booster buffer (e.g., flag fWriteBoosterEn is enabled) with all logical units sharing the write boost buffer, which may occur when the bWriteBoosterBufferType is configured as 01h-shared type. If all data received at the flash storage device is first stored in the write booster buffer, then the write booster buffer may have a much shorter lifetime than the normal storage which ultimately receives the data written to the flash storage.

However, in many operating conditions supporting many applications, not all data from a host device needs to be written so quickly as to require the use of the write booster buffer. For example, longer-term storage (e.g., digital photographs from a camera) may not operationally place much value in quickly storing the data (e.g., low latency). In contrast, video applications, for example, may need data write operations to be accelerated via the write booster buffer so that local storage or cache does not fill up from the sequence of image frame data.

Depending on the application running on the computing device, the host controller may have information identifying a latency requirement or a priority of data associated with a write operation of the application. Without control over what data uses the write booster buffer, the write booster buffer may not be optimized to focus on this priority data. As a result, lower priority data and data with no urgency or latency requirements may fill up the write booster buffer, thus interfering with or delaying storage of higher priority data with stringent latency requirements.

Various embodiments address and overcome the foregoing problems of inefficiently using the write booster buffer in a FLASH memory device and wasting the limited write cycles of its lifetime on low priority write commands by enabling the UFS device to obtain and act on commands from the host that manage use of the write booster buffer in order to more effectively use the write cycles of the write booster buffer. Various embodiments enable a UFS device to obtain information or receive commands from a host controller that indicate whether the write booster buffer should be used for one or more subsequent data transmissions. This enables a host controller to control a UFS device to write data to memory via a write booster buffer or directly to one or more logical units of memory in normal storage.

The host controller may transmit a command containing instructions that indicate one or more logical units of memory to be allowed to use the write booster buffer. In some embodiments, the host controller may configure a memory table stored on the UFS device that indicates the logical units that use the write booster buffer. A UFS device controller may then access the memory table to obtain information containing a write type for incoming data directed to each logical unit. In some embodiments, the host controller may transmit a command (e.g., a UPIU) containing instructions that indicate one or more subsequent data transmissions to write to the write booster buffer or to normal memory based on one or more set values. Based on this information, the device controller of the UFS device may send certain data to the write booster buffer and may direct other data to bypass the write booster buffer and be written directly in normal memory (e.g., TLC NAND) storage of the identified logical unit.

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices. The host controller may form a portion of the SoC and the UFS device may form a portion of the SoC.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

As used herein, the term “processing system” is used herein to refer to one or more processors, including multi-core processors, that are organized and configured to perform various computing functions. Various embodiment methods may be implemented in one or more of multiple processors within a UFS memory device or host memory controller as described herein. The term “UFS” or Universal Flash Storage and the term “flash storage device” are interchangeable herein.

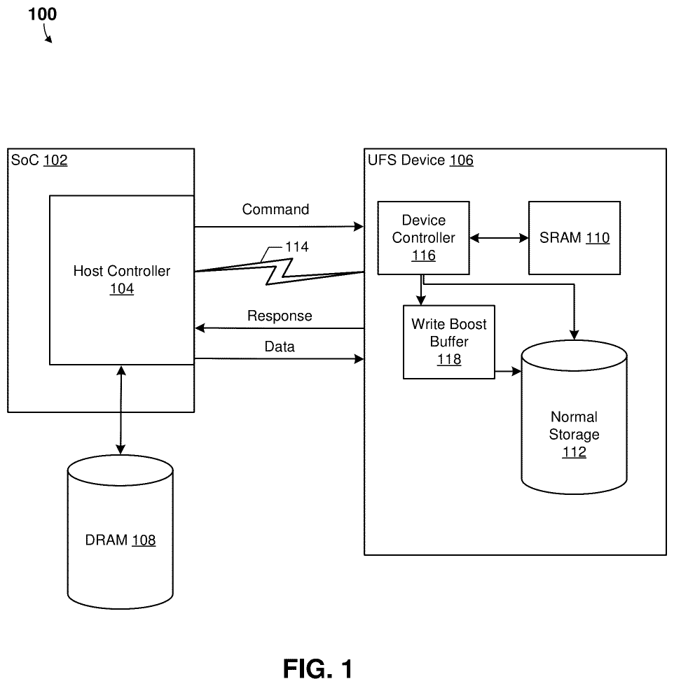

FIG. 1 is a system block diagram illustrating an example system suitable for implementing any of the various embodiments. The system 100 may include one or more computing devices or processors connected to a UFS device 106 for storage. For example, the system 100 may include an SoC 102 including a host controller 104, a dynamic random access memory (DRAM) 108 communicably connected to the host controller 104, and a UFS device 106 communicably connected to the host controller 104 via a link 114. The flows of command, data, and response illustrated between the SoC 102 and the UFS device 106 may be carried or transmitted over link 114. The host controller 104 may include a processor (not shown separately) configured to perform operations of the host controller described herein. The host controller 104 may maintain and access stored data in DRAM 108 or an SRAM (not shown), and/or the host controller 104. The SRAM of the host controller 104 may be a part of the SoC 102.

The UFS device 106 may include a device controller 116, a static random access memory (SRAM) 110, a write booster buffer (e.g., SLC NAND memory) 118, and a normal storage (e.g., TLC NAND memory) 112. The device controller 116 may include one or more processors, which may be configured as a processing system configured to implement operations of various embodiments. The device controller 116 may be connected to the SRAM 110 and the normal storage 112, such that the device controller 116 may select different memory locations for storage and control flows of information to memory (e.g., 110, 112, 118). The write booster buffer 118 may be connected to the device controller 116 and the normal storage 112, such that the write booster buffer buffers data written from the host controller 104 via the device controller 116 to the normal storage 112. In addition, the normal storage 112 may be connected to the device controller 116 independent from the write booster buffer 118 to directly store data written from the host controller 104 when the device controller 116 has been instructed (or is configured) to bypass the write booster buffer 118.

The host controller 104 may implement write transactions to the UFS device 106. The write transactions may include the host controller 104 issuing write commands from other components of the SoC 102 and/or from components communicably connected to the SoC 102 (e.g., via I/O of the SoC) to the device controller 116. The write transactions may also include data out UFS protocol information units (UPIUs) transferring the write data from the host controller 104 to the device controller 116.

The device controller 116 receiving the write commands and data out UPIUs from the host controller 104 may write the data of the data out UPIUs to the write booster buffer 118. The device controller 116 may manage the write booster buffer 118 storing the data, including controlling flushing the data from the write booster buffer 118 to the normal storage 112. The device controller 116 may implement flushing the data from the write booster buffer 118 to the normal storage 112 periodically, episodically, etc. The device controller 116 may maintain a memory mapping table at the UFS device 106 with addresses at the normal storage 112 and write booster buffer 118. The memory table may include parameters and controls for different portions of normal storage 112, such as a logical unit number (LUN) for each of a plurality of logical units of memory.

In some embodiments, the device controller 116 may be configured to update a write type register that corresponds to each LUN of the normal storage 112. The write type register may operate as an enable flag for each of the LUNs via an 8-bit value sequence that identifies the write type status of each LUN. The write type may be to enable shared memory (e.g., write to the write booster buffer 118) or to disable shared memory and write directly to normal storage 112. This write type register may be set during provisioning to a default setting (e.g., LUNs 1-8 are enabled for shared write booster). This write type register may be updated in the memory table by a UPIU command that designates one or more LUNs and one or more write type statuses for each of them (or collectively).

In some embodiments, the device controller 116 may be configured to update a write type register that corresponds to a series of incoming data packets directed to a LUN. The device controller 116 may receive a UPIU command that includes an expected length of the subsequent transfer to which the write type update applies. After the expected transfer corresponding to that command is complete, the device controller may revert back to a default write type (e.g., disabled shared write to write booster) for that LUN. The device controller 116 may record that data directed to a LUN is set at a specific write type (e.g., shared enabled/disabled) until another UPIU command updates the write type for that LUN. Based on these commands and defaults, the device controller 116 may decide to write the received data from the host controller 104 to respective memory elements, such as SLC or TLC memory elements.

The host controller 104 may implement read transactions at the UFS device 106. Read transactions may include the host controller 104 issuing read requests from other components of the SoC 102 and/or from components communicably connected to the SoC 102 (e.g., via I/O of the SoC) to the device controller 116. Read transactions may also include data in UPIUs transferring the read addresses from the host controller 104 to the device controller 116. The read addresses may be physical addresses corresponding to logical addresses received by the host controller 104 from the other components of the SoC 102 and/or from components communicably connected to the SoC 102. Read transactions may be subsequent to write transactions and may read the data out of the normal storage 112. As illustrated, the host controller 104 may transmit commands (including read commands) and data to the UFS device 106 over link 114 and the UFS device 106 may transmit a response which acknowledges receipt and/or requests the next transmission.

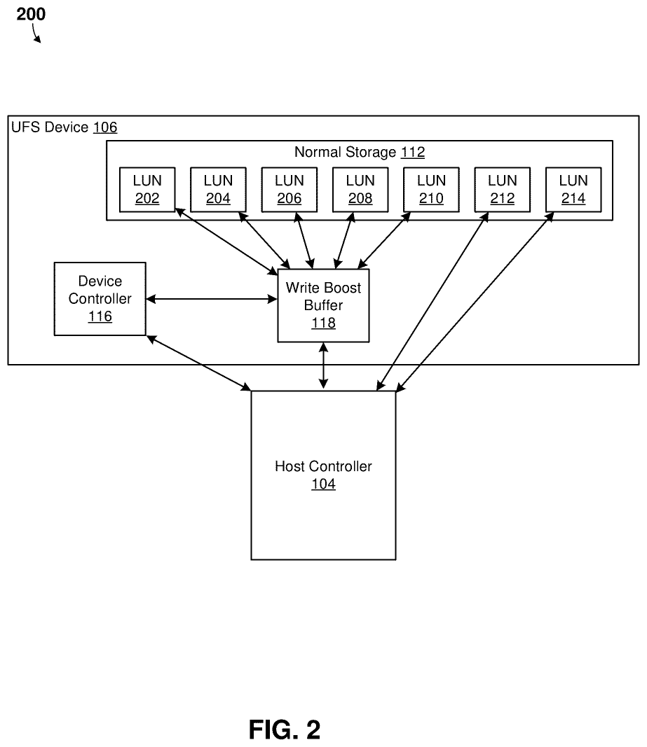

FIG. 2 is a system block diagram illustrating an example memory system 200 suitable for implementing any of the various embodiments. With reference to FIGS. 1 and 2, the illustrated example UFS device 106 includes a device controller 116 which may include a processing system, a write booster buffer 118, and normal storage 112. The normal storage 112 may include a plurality of logical unit numbers (LUNs) that may correspond to blocks of logical addresses of NAND memory. A Logical Unit Number is typically used to identify a logical storage partition or device within a UFS device or system. The LUNs may be individually addressable by the host controller 104. The device controller 116 may be connected to the write booster buffer 118 and may include one or more processors in a processing system configured to send commands and requests to the write booster buffer 118. The arrows illustrated in FIG. 2 show data flows between the host controller 104 and the LUNs and device controller 116 in an example where various LUNs are write booster enabled and others are not. In general, the device controller 116 may command the write booster buffer 118 to flush data to normal memory 112 or control inputs to redirect input data directly to the normal storage 120, or other control commands as described in the UFS 4.0 specification or updates thereof.

As illustrated, data flows from the host controller 104 may be directed to the write booster buffer 118 first for quicker throughput to the UFS device 106 or these data flows may be directed to bypass the write booster buffer 118 and directly save the data in the normal storage 112. Eventually data in the write booster buffer 118 is flushed by the device controller 116 to the appropriate LUN as shown. After a write of data is completed to the write booster buffer 118 or normal storage 112, the device controller 116 may transmit a response to the host controller 104. As described with respect to FIG. 1, the host controller 104 may transmit to one or more LUNs and may designate one or more LUNs (e.g., 202, 204, 206, 214) as destinations for a data transmission. The LUN addresses may be an 8-bit variable allowing up to thirty-two LUNs to be individually addressed.

In some embodiments, the device controller 116 may store a memory table that contains parameters and configurations corresponding to each of the LUNs (e.g., 202, 204, 206, 208, 210, 212, 214). The device controller 116 may signal via a write booster buffer support flag that it is capable of bypassing the write booster buffer 118 on a per LUN basis. The host controller 104 may read this write booster buffer support flag to determine how to configure the UPIU commands and ensure that the write commands are supported. The host controller 104 may command the device controller 116 to configure a memory table to enable shared write booster buffer access for LUNs 202, 204, 206, 208, and 210 (e.g., set a write type variable in the memory table for one or more LUNs). Subsequent write commands and data transmissions to these LUNs of the UFS device 106 may then be written to the write booster buffer 118. A data transmission to LUN 212 or LUN 214 may be written to normal storage 112 and may bypass the write booster buffer 118.

In some embodiments, the device controller 116 may manage usage of the write booster buffer 118 based on a flag or value provided in the UPIU write command. Based on the UPIU write command and a write type provided therein, the device controller 116 may store subsequent data in the write booster buffer 118 or directly in normal storage 112. The subsequent data may be designated by the write command and/or may be data destined for a particular LUN which was assigned a particular write type based on the command. In other words, the write type indicated in the UPIU command beginning a data transfer may enable or disable write booster buffer usage on a per write command basis or on a per LUN basis, or a combination.

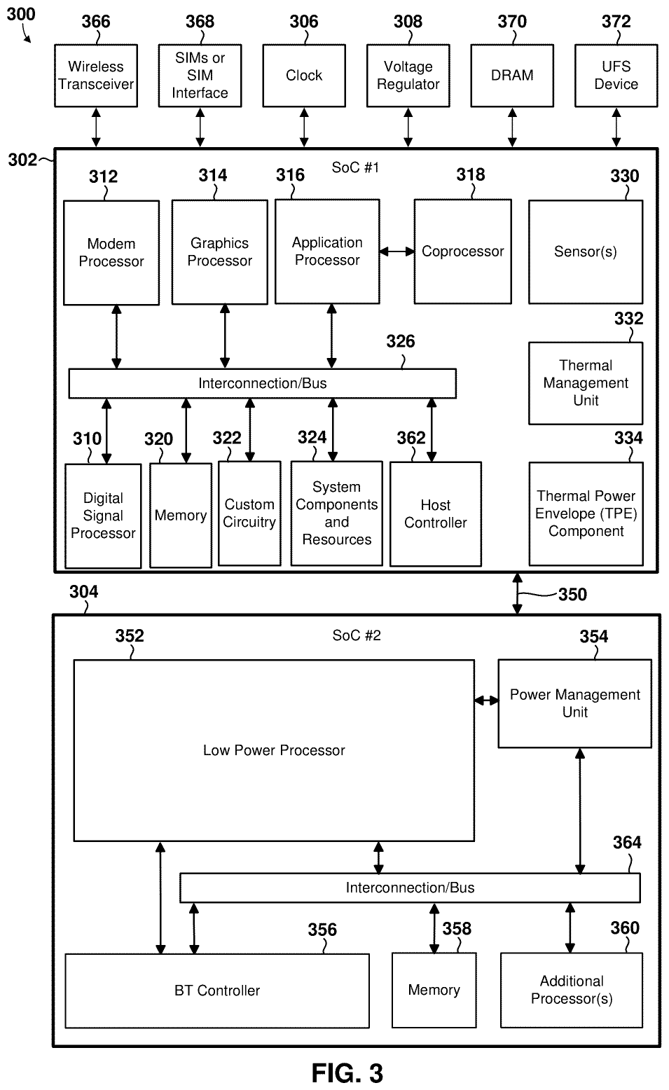

FIG. 3 is a component block diagram illustrating an example computing device 300 suitable for implementing any of the various embodiments. Various embodiments may be implemented on a number of single-processor and multi-processor computer systems, including a system-on-chip (SoC) or system in a package (SIP).

With reference to FIGS. 1-3, the illustrated example computing device 300 (which may be a system-in-a-package in some embodiments) includes two SoCs 302, 304 (e.g., SoC 102) coupled to a clock 306, a voltage regulator 308, at least one subscriber identity module (SIM) 368 and/or a SIM interface, a DRAM 370 (e.g., DRAM 108), a UFS device 372 (e.g., UFS device 106) for storage, a wireless transceiver 366 configured to send and receive wireless communications via an antenna (not shown) to/from wireless computing devices, such as a base station, wireless device, and/or computing device (e.g., system 100). In some embodiments, the first SoC 302 may operate as central processing unit (CPU) of the computing device 300 that carries out the instructions of software application programs by performing the arithmetic, logical, control and input/output (I/O) operations specified by the instructions. In some embodiments, the second SoC 304 may operate as a specialized processing unit. For example, the second SoC 304 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SoC 302 may include a digital signal processor (DSP) 310, a modem processor 312, a graphics processor 314, an application processor (AP) 316, one or more coprocessors 318 (e.g., vector co-processor) connected to one or more of the processors (e.g., 312, 314, 316), memory 320, custom circuitry 322, system components and resources 324, a host controller 362 (e.g., host controller 104), an interconnection/bus module 326, one or more sensors 330 (e.g., accelerometer, temperature sensor, pressure sensor, optical sensor, infrared sensor, analog sound sensor, etc.), a thermal management unit 332, and a thermal power envelope (TPE) component 334. The second SoC 304 may include a low power processor 352, a power management unit 354, an interconnection/bus module 364, a BT controller 356, memory 358, and various additional processors 360, such as an applications processor, packet processor, etc.

Each processor 310, 312, 314, 316, 318, 352, 360 may include one or more cores, and each processor/core may perform operations independent of the other processors/cores. For example, the first SoC 302 may include a processor that executes a first type of operating system (e.g., FreeBSD, LINUX, OS X, etc.) and a processor that executes a second type of operating system (e.g., MICROSOFT WINDOWS 10). In addition, any or all of the processors 310, 312, 314, 316, 318, 352, 360 may be included as part of a processor cluster architecture (e.g., a synchronous processor cluster architecture, an asynchronous or heterogeneous processor cluster architecture, etc.).

The first and second SoC 302, 304 may include various system components, resources, and custom circuitry for managing sensor data, analog-to-digital conversions, wireless data transmissions, and for performing other specialized operations, such as decoding data packets and processing encoded audio and video signals for rendering in a web browser or audio/video application. For example, the system components and resources 324 of the first SoC 302 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 324 and/or custom circuitry 322 may also include circuitry to interface with peripheral devices, such as cameras, electronic displays, wireless communication devices, external memory chips, etc.

The first and second SoC 302, 304 may communicate via interconnection/bus module 350. In some embodiments, the interconnection/bus module 350 may be a connection established by transceiving (i.e., receiving and transmitting) components within both the SoC 302 and SoC 304. For example, the low power processor 352 may include a universal asynchronous receiver-transmitter (UART) and the application processor 316 may include a multiple signal messages (MSM) UART driver that is communicatively connected to the UART of the low power processor 352.

The various processors 310, 312, 314, 316, and 318, may be interconnected to one or more memory elements 320, system components and resources 324, and custom circuitry 322, and a thermal management unit 332 via an interconnection/bus module 326. Similarly, the low power processor 352 may be interconnected to the power management unit 354, the BT controller 356, memory 358, and various additional processors 360 via the interconnection/bus module 364. The interconnection/bus module 326, 350, 364 may include an array of reconfigurable logic gates and/or implement a bus architecture (e.g., CoreConnect, AMBA, etc.). Communications may be provided by advanced interconnects, such as high-performance networks-on chip (NoCs).

In various embodiments, any or all of the processors 310, 312, 314, 316, and 318 in the system may operate as the SoC's main processor, central processing unit (CPU), microprocessor unit (MPU), arithmetic logic unit (ALU), etc. One or more of the coprocessors 318 may operate as the CPU. In addition to the example SIP 100 discussed above, various embodiments may be implemented in a wide variety of computing systems, including a single processor, multiple processors, multicore processors, or any combination thereof.

The first and/or second SoCs 302, 304 may further include an input/output module (not illustrated) for communicating with resources external to the SoC, such as a clock 306, a voltage regulator 308, one or more wireless transceivers 366, and at least one SIM 368 and/or SIM interface (i.e., an interface for receiving one or more SIM cards). Resources external to the SoC (e.g., clock 306, voltage regulator 308) may be shared by two or more of the internal SoC processors/cores. The at least one SIM 368 (or one or more SIM cards coupled to one or more SIM interfaces) may store information supporting multiple subscriptions, including a first 5GNR subscription and a second 5GNR subscription, etc.

In addition to the example computing device 300 discussed above, various embodiments may be implemented in a wide variety of computing systems, which may include a single processor, multiple processors, multicore processors, or any combination thereof.

In some embodiments, the various processors of the SoC 302 and SoC 304 may be located within the same SoC. For example, the application processor 316 and low power processor 352 may be located within a same SoC, such as in a single SoC of a wearable device, to perform optimized storage routines with the UFS device 372.

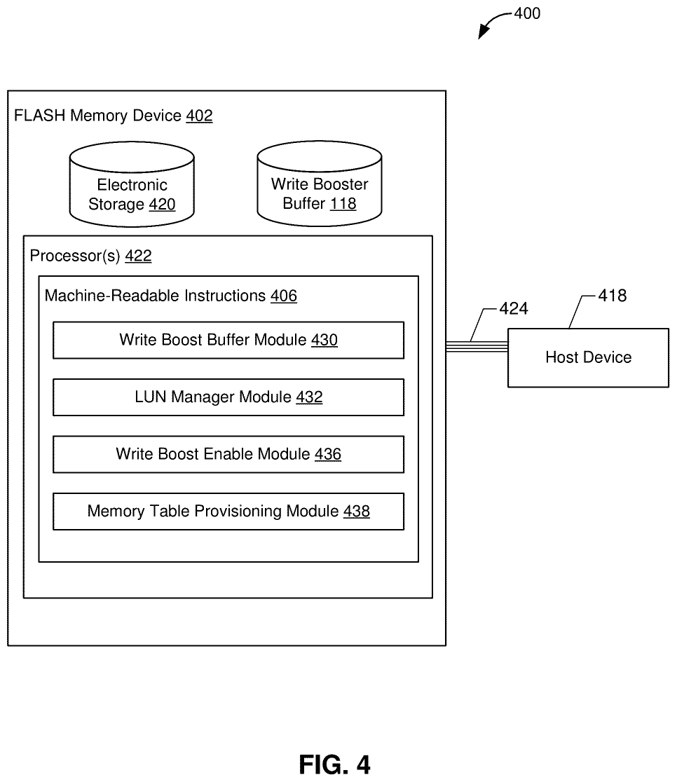

FIG. 4 is a component block diagram illustrating an example system 400 configured for UFS read throughput enhancements according to some embodiments. With reference to FIGS. 1-4, the system 400 may include a FLASH memory device 402 and a host device 418, which may communicate via a communication link 424 (e.g., link 114). Host device 418 may be a processing system of a computing device that may transmit read and write requests to the FLASH memory device 402. The system 400 may include a plurality of hardware, software, and/or firmware components operating together to provide the functionality attributed herein to the processor(s) 422 (e.g., UFS device controller 116). The FLASH memory device 402 may include a write booster buffer 118 (e.g., write booster buffer 118, SLC NAND memory) that receives and temporarily stores (i.e., buffers) data to be written to and stored in the electronic storage 420 as described herein.

The FLASH memory device 402 may include electronic storage 420 (e.g., normal storage 112) that may be configured to store information as instructed by the processors 422 via machine-readable instructions 406. The electronic storage 420 may include FLASH-type non-transitory storage media (e.g., read-only memory) that electronically stores information.

The electronic storage 420 may store software algorithms, information determined by processor(s) 422 of a processing system, and/or other information that enables the FLASH memory device 402 to function as described herein.

The FLASH memory device processor(s) 422 may be configured by machine-readable instructions 406. Machine-readable instructions 406 may include one or more instruction modules. The instruction modules may include computer program modules. The instruction modules may include one or more of a write booster buffer module 430, a LUN manager module 432, a write booster enable module 436, a memory table provisioning module 438, and other instruction modules (not illustrated). The FLASH memory device 402 may include one or more processor(s) 422 of a processing system configured to implement the machine-readable instructions 406 and corresponding modules.

In some embodiments, the processor(s) 422 executing the write booster buffer module 430 may be configured to manage and optimize usage of the write booster buffer 118. For example, the write booster buffer module 430 may be configured to control implementing a flush of contents of a write booster buffer 118 (e.g., SLC NAND memory) of the UFS device 402 to a normal storage in the electronic storage 420 (e.g., normal storage 112, TLC NAND memory) of the UFS device. The flush may be implemented periodically, episodically, etc. For example, the flush may be implemented one or more times per read transaction, such as per data out UPIU received at the UFS device. As another example, the flush may be implemented at reaching a capacity threshold for the write booster buffer.

In some embodiments, the processor(s) 422 executing the write booster buffer module 430 may be configured to store one or more memory tables to manage the electronic storage 420 (e.g., write booster buffer 118). These memory tables may map addresses between shared memory and normal storage 112 (e.g., to manage flushing operations). The memory tables may also configure data directed to one or more normal storage addresses (e.g., LUNs) to be directed directly to the normal storage 112, 420 and may bypass the write booster buffer 118. The processor(s) 422 executing the write booster buffer module 430 may be configured to assess on its own based on priority information associated with the incoming data to be written whether to store the data in shared memory (e.g., the buffer) or bypass the shared memory and store in normal storage 112 (e.g., for low priority). The processor(s) 422 executing the write booster buffer module 430 may be configured to transmit a response to a host device 418 (e.g., host controller 104) when a data transmission or portion thereof has been received and stored on the write booster buffer 118.

In some embodiments, the processor(s) 422 executing the LUN manager module 432 may record and monitor storage on LUNs which have been designated as direct write such that data bypasses the write booster buffer 118. In other words, the LUN manager module 432 may provide an acknowledgement to the device controller 116 that data has been fully written and may report its physical or logical address. Likewise, the LUN manager module 432 may acknowledge transfer of data that has been flushed from the write booster buffer 118 so that the device controller can properly record the updated data location (e.g., physical or logical address). The acknowledgements may include response UPIUs to write transactions from the host device 418.

In some embodiments, the processor(s) 422 executing the write booster enable module 436 may be configured to monitor for changes to the write type of one or more LUNs. The write booster enable module 436 may include one or more conditional paths that are configured based on the write type status of the LUNs so that the appropriate data transmissions are directed to the write booster buffer 118 and normal storage 112, 420. The write booster enable module 436 may adjust the routing of data based on a write type or a shared memory enable flag that has been received at the FLASH memory device 402 from the host device 418.

In some embodiments, the processor(s) 422 executing the memory table provisioning module 438 may be configured to execute upon a start-up signal or at power ON of the FLASH memory device 402. Upon boot the processors 422 may execute instructions to assign default values to a memory table that is used to manage the write processes of the write booster buffer 118 as described with respect to the write booster buffer module 430 and the LUN manager 432. For example, the default values assigned may set a write booster buffer type as a shared type or other type and may set a write booster enable flag to enabled or disabled. The provisioning of the memory table may be determined by extensible markup up language (XML) information that is stored for this purpose (e.g., in electronic storage 420).

The description of the functionality provided by the different modules 430-438 is for illustrative purposes, and is not intended to be limiting, as any of modules 430-438 may provide more or less functionality than is described. For example, one or more of modules 430-438 may be eliminated, and some or all of its functionality may be provided by other ones of modules 430-438. As another example, processor(s) 422 may execute one or more additional modules that may perform some or all of the functionality attributed below to one of modules 430-438.

In some embodiments, the write booster buffer module 430, the LUN manager module 432, the write booster enable module 436, and the memory table provisioning module 438 may be implemented by a UFS device controller executing in the processor(s) 422 (e.g., device controller 116) of the FLASH memory device 402, which may be and/or may include processor 422.

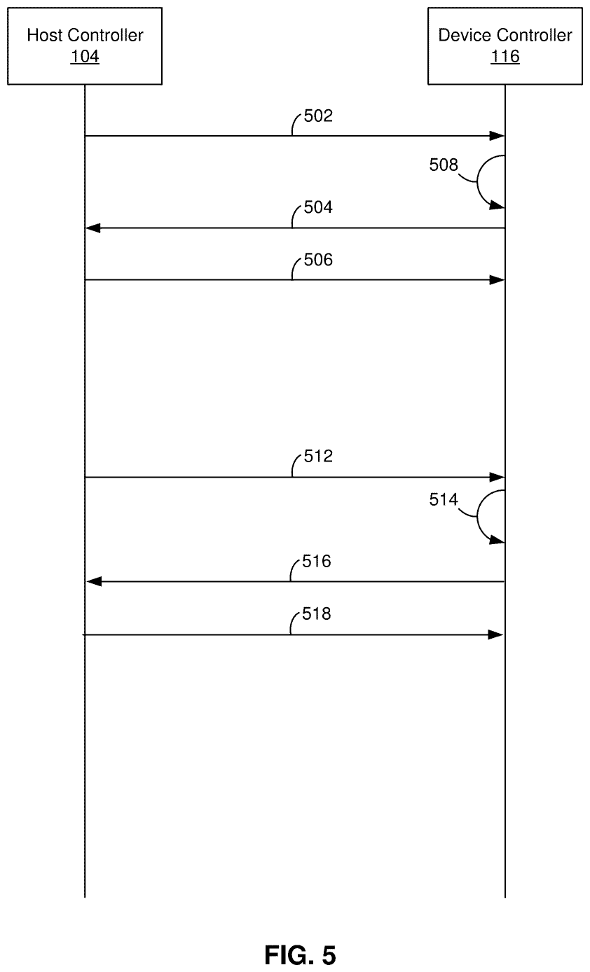

FIG. 5 is a signal flow and operations diagram illustrating an example of write booster buffer optimization according to some embodiments. With reference to FIGS. 1-5, a host controller 104 (e.g., 104, 418) of an SoC (e.g., SoC 102, 302) may be communicably connected to a device controller 116 of a UFS device (e.g., UFS device 106, 402, 372, processor 422) via a link (e.g., link 114, 424). The host controller 104 and the device controller 116 may each include one or more processors in a processing system configured to execute computer code to implement computing operations. The host controller 104 and the UFS device controller 116 may each be configured to send and receive signals, which may include computing data and/or computing instructions, between components of a computing device including between each other, via the link.

The host controller 104 may send a write UPIU command to be implemented at the UFS device in operation 502. The device controller 116 may respond to receiving the write command with a ready to transfer signal in operation 504. The host controller 104 may send one or more data-out UPIUs, including data and/or addresses at a write booster buffer (e.g., write booster buffer 118, SLC NAND memory) in operation 506 or data and addresses at one or more LUNs (e.g., normal storage 120). In some examples, the host controller 104 may update an address mapping table at the host device to associate logical addresses for the data of the write command with physical addresses of the write booster buffer or one or more LUNs at which to store the data.

The device controller 116 may set one or more shared memory enable flags for one or more LUNs in operation 508 based on the received UPIU write command from operation 502. In some examples, the UPIU write command from operation 502 may include a change to a memory table of the device controller 116 that provides routing for data received at the device controller 116 (e.g., data out 506). The write command may designate one or more LUNs for the subsequent data-out operations and may command the device controller 116 to enable or disable shared memory (e.g., write booster buffer 118) for one or more LUNs. This write command may be processed by the device controller 116 by updating a memory table as described with respect to FIG. 4.

In some embodiments, the host controller 104 may send a write command UPIU to be implemented at the UFS device in operation 512. The device controller 116 may respond to receiving the write command with a ready to transfer signal in operation 516. The host controller 104 may send one or more data-out UPIUs in operation 518, including data and/or addresses at a write booster buffer (e.g., write booster buffer 118, SLC NAND memory) or data and addresses at one or more LUNs (e.g., normal storage 120). In some examples, the device controller 116 may set one or more write type variables or fields corresponding to one or more LUNs in operation 514 based on information in the write command 512. Subsequent write command UPIUs may similarly change this write type variable based on the priority or latency requirement of the data associated with the write command. The write type of a LUN may thereby be adapted to the incoming data so as to optimize usage of the write booster buffer 118.

When the host device needs to access the data stored by these write commands, the host controller 104 may send the read command UPIUs with physical addresses or logical addresses for data at the normal storage 112. The device controller 116 may retrieve the read data using the physical addresses or logical addresses at the normal storage 112 from the read request and return the read data to the host controller 104.

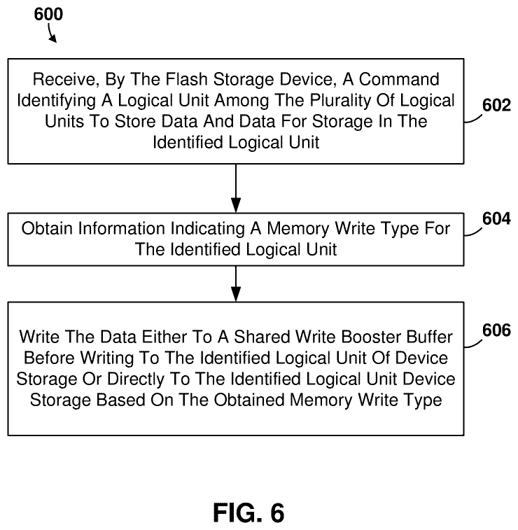

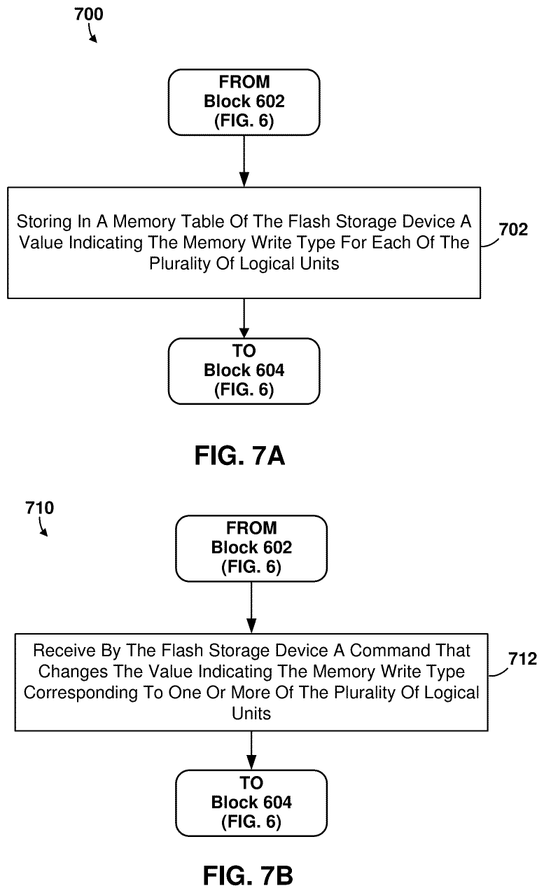

FIG. 6 is a process flow diagram of an example method 600 that may be performed by a UFS device controller (e.g., by a processor or processing system within the UFS device controller) of a flash storage device for write booster buffer optimization in accordance with various embodiments. With reference to FIGS. 1-6, the method 600 may be performed by a UFS device controller (e.g., device controller 116) of a flash storage device (e.g., 106). The UFS device controller may include one or more processors in a processing system (e.g., processor 322, 422) one or more of which may be configured by processor-executable instructions stored in a non-transitory processor-readable medium (e.g., memory 110) to perform operations of the method 600. Means for performing the operations of the method 600 may be the UFS device controller, the processor or processing system, and/or the like as described with reference to FIGS. 1-6. In order to encompass the alternative configurations enabled in various embodiments, the hardware implementing the method 600 is referred to herein as a “processing system.”

In block 602, a UFS device controller of a flash storage device may receive a command identifying a logical unit among the plurality of logical units in which to store data and the data for storage in the identified logical unit (e.g., LUN). The write command may be received by the UFS device controller from a host device (e.g., SoC 102, 302, host controller 104, 418). In some embodiments, receiving the command may include receiving the information in the command indicating the memory write type. For example, the command may comprise a bit in a command Universal Flash Storage (UFS) Protocol Information Unit (UPIU) in which the bit of one value indicates that subsequent data should be written to a shared write booster buffer before writing to device storage of the logical unit identified in the command UPIU or written directly to device storage of the identified logical unit identified in the command UPIU. In some embodiments, receiving the command may include changing a shared memory enable flag in a memory table for one or more LUNs identified in the command.

In block 604, the UFS device controller of the flash storage device may obtain information indicating a memory write type for the identified logical unit. In some embodiments, obtaining the information indicating the memory write type may involve or include obtaining the changed shared memory enable flag in a memory table for one or more LUNs identified in the command. In some embodiments, obtaining the information may include obtaining information indicating the memory write type for the identified logical unit comprises obtaining, from the memory table, the value indicating the memory write type corresponding to the identified logical unit. In some embodiments, obtaining the information indicating the memory write type may include obtaining the information from the command identifying the logical unit to store the data.

In block 606, the UFS device controller of the flash storage device may write the data to either a shared write booster buffer before writing to device storage of the identified logical unit or directly to device storage of the identified logical unit based on the obtained memory write type to which the data is written to process write commands. For example, if a command (or a value obtained from the memory table) indicates that the shared write booster buffer is enabled for a LUN, then data destined for the LUN may be written to the shared write booster buffer before being flushed to the device storage of the LUN (e.g., LUN 202 of FIG. 2). If the command (or the value obtained from the memory table) indicates that the shared write booster buffer is disabled for a LUN, then data destined for the LUN may be written directly to the LUN in device storage, bypassing the shared write booster buffer (e.g., LUN 212 of FIG. 2). In some embodiments, this decision of where to write the data may be toggled by the write command on a per-LUN basis or on a per-command and per-LUN basis.

FIG. 7A is a process flow diagram of an example method 700 that may be performed by a device controller (e.g., by a processor within the device controller) of a computing device for write booster buffer usage optimization in accordance with various embodiments. With reference to FIGS. 1-7A, the method 700 may be performed by a device controller (e.g., device controller 116) of a computing device (e.g., system 100, computing device 300). In some embodiments, the host controller may include one or more processors of a processing system (e.g., processor 422) configured to perform the operations by processor-executable instructions stored in a non-transitory processor-readable medium (e.g., memory 320, electronic storage 420). Means for performing the operations of the method 700 may be the device controller, the processor, and/or the like as described with reference to FIGS. 1-7A. With reference to FIGS. 1-7A, the method 700 may be performed in a computing device by processing system encompassing one or more processors (e.g., 310, 312, 314, 316, 318, 321, 322, 352, 360, etc.), components or subsystems discussed in this application. Means for performing the functions of the operations in the method 700 may include a processing system including one or more of processors 310, 312, 314, 316, 318, 321, 322, 352, 360, and other components described herein.

In some embodiments, the method 700 may be implemented in parallel (or together) with the method 600 described with reference to FIG. 6. For example, the UFS device controller implementing the method 700 may be the same as a UFS device controller and/or part of the UFS device described in the method 600, and the host controller implementing the method 700 may be the same as the host controller and/or part of the host device described for the method 600.

In block 702, the method 700 may continue from block 602 of FIG. 6 and may store in a memory table of the flash storage device a value indicating the memory write type as directed to the shared write booster buffer or device storage for each of the plurality of logical units. The method 700 may then continue to block 604 of FIG. 6 and on to block 606 of FIG. 6 as described for method 600. In some embodiments, obtaining the information indicating the memory write type may include obtaining, from the memory table, the value indicating the memory write type corresponding to the identified logical unit.

FIG. 7B is a process flow diagram of an example method 710 that may be performed by a device controller (e.g., by a processor within the device controller) of a computing device for write booster buffer usage optimization in accordance with various embodiments. With reference to FIGS. 1-7B, the method 710 may be performed by a host controller (e.g., device controller 116) of a computing device (e.g., system 100, computing device 300). In some embodiments, the device controller may include a processor (e.g., processor 422) configured to perform the operations by processor-executable instructions stored in a non-transitory processor-readable medium (e.g., memory 320, electronic storage 420). Means for performing the operations of the method 710 may be the host controller, the processor, and/or the like as described with reference to FIGS. 1-7B. With reference to FIGS. 1-7B, the method 710 may be performed in a computing device by processing system encompassing one or more processors (e.g., 310, 312, 314, 316, 318, 321, 322, 321, 322, 352, 360, etc.), components or subsystems discussed in this application. Means for performing the functions of the operations in the method 710 may include a processing system including one or more of processors 310, 312, 314, 316, 318, 321, 322, 321, 322, 352, 360, and other components described herein.

In some embodiments, the method 710 may be implemented in parallel (or together) with the method 600 described with reference to FIG. 6. For example, the UFS device controller implementing the method 710 may be the same as a UFS device controller and/or part of the UFS device described in the method 600, and the host controller implementing the method 710 may be the same as the host controller and/or part of the host device described for the method 600.

In block 712, the method 710 may continue from block 602 of FIG. 6 and may receive, at the flash storage device, a command that changes, enables, or disables the value indicating the memory write type corresponding to one or more of the plurality of logical units. In some embodiments, the obtaining the information indicating a memory write type (e.g., block 604) for data may include obtaining the information indicating the memory write type from the write command UPIU identifying the logical unit to store the data. The method 710 may then continue to block 604 of FIG. 6 and on to block 606 of FIG. 6 as described for method 600.

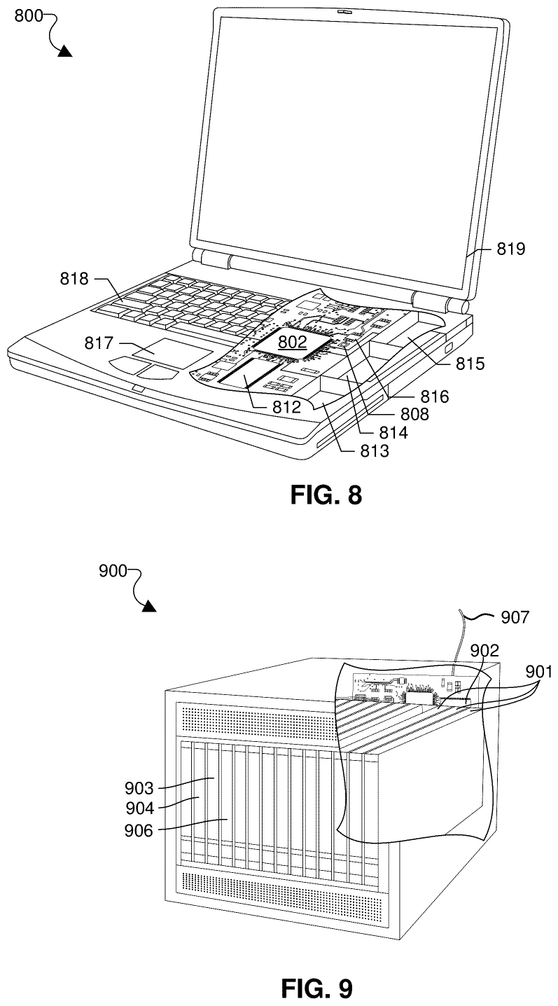

Various embodiments (including, but not limited to, embodiments described with reference to FIGS. 1-7B) may be implemented in a wide variety of computing systems, which may include a laptop computer 800 (e.g., computing device 100, 300, 402), an example of which is illustrated in FIG. 8. With reference to FIGS. 1-8, a laptop computer may include a touchpad touch surface 817 that serves as the computer's pointing device, and thus may receive drag, scroll, and flick gestures similar to those implemented on computing devices equipped with a touch screen display and described above. A laptop computer 800 will typically include a processor 802 coupled to volatile memory 812 and a large capacity nonvolatile memory, such as a disk drive 813 of Flash memory. Additionally, the computer 800 may have one or more antenna 808 for sending and receiving electromagnetic radiation that may be connected to a wireless data link and/or cellular telephone transceiver 816 coupled to the processor 802. The computer 800 may also include a floppy disc drive 814 and a compact disc (CD) drive 815 coupled to the processor 802. The laptop computer 800 may include a touchpad 817, a keyboard 818, and a display 819 all coupled to the processor 802. Other configurations of the computing device may include a computer mouse or trackball coupled to the processor (e.g., via a universal serial bus (USB) input) as are well known, which may also be used in conjunction with the various embodiments.

FIG. 9 is a component block diagram of a computing device 900, such as a server, suitable for use with various embodiments. Such computing devices may include at least the components illustrated in FIG. 9. With reference to FIGS. 1-9, the computing device 900 (e.g., computing device 100, 300, 402) may include a processor 901 coupled to volatile memory 902 and a large capacity nonvolatile memory, such as a disk drive 903.

The computing device 900 may also include a peripheral memory access device such as a floppy disc drive, compact disc (CD) or digital video disc (DVD) drive 906 coupled to the processor 901. The computing device 800 may also include network access ports 904 (or interfaces) coupled to the processor 901 for establishing data connections with a network, such as the Internet and/or a local area network coupled to other system computers and servers.

The computing device 900 may include one or more antennas 907 for sending and receiving electromagnetic radiation that may be connected to a wireless communication link. The computing device 900 may include additional access ports, such as USB, Firewire, Thunderbolt, and the like for coupling to peripherals, external memory, or other devices.

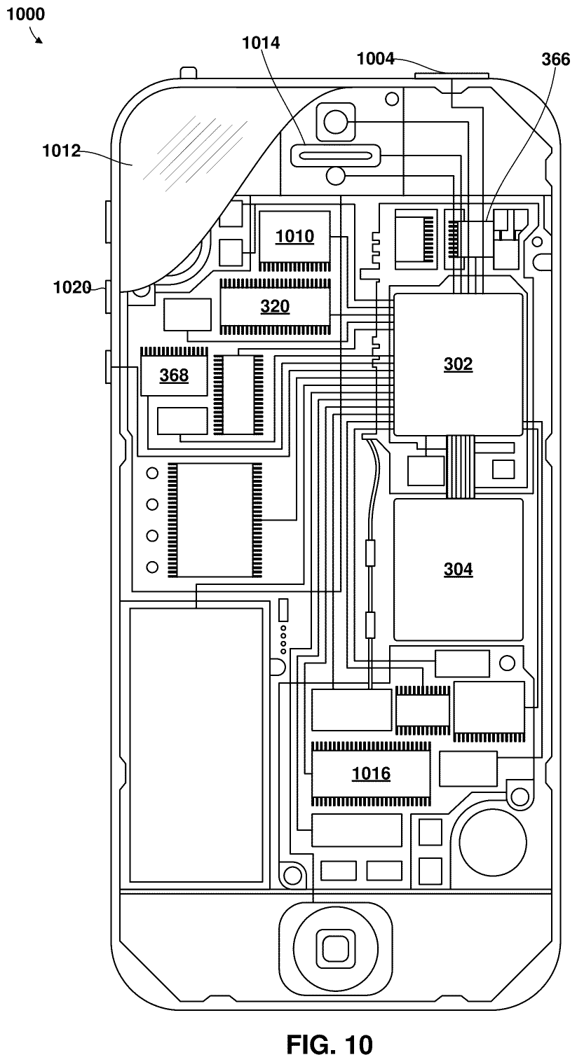

FIG. 10 is a component block diagram of a computing device 1000 suitable for use with various embodiments. With reference to FIGS. 1-10, various embodiments may be implemented on a variety of computing devices 1000 (e.g., computing device 100, 300, 402), an example of which is illustrated in FIG. 10 in the form of a smartphone. The computing device 1000 may include a first SoC 302 (e.g., a SoC-CPU) coupled to a second SoC 304 (e.g., a 5G capable SoC). The first and second SoCs 302, 304 may be coupled to internal memory 1016, a display 1012, and to a speaker 1014. The first and second SoCs 302, 304 may also be coupled to at least one SIM 368 and/or a SIM interface that may store information supporting a first 5GNR subscription and a second 5GNR subscription, which support service on a 5G non-standalone (NSA) network.

The computing device 1000 may include an antenna 1004 for sending and receiving electromagnetic radiation that may be connected to a wireless transceiver 366 coupled to one or more processors in the first and/or second SoCs 302, 304. The computing device 1000 may also include menu selection buttons or rocker switches 1020 for receiving user inputs.

The computing device 1000 also includes a sound encoding/decoding (CODEC) circuit 1010, which digitizes sound received from a microphone into data packets suitable for wireless transmission and decodes received sound data packets to generate analog signals that are provided to the speaker to generate sound. Also, one or more of the processors in the first and second SoCs 302, 304, wireless transceiver 366 and CODEC 1010 may include a digital signal processor (DSP) circuit (not shown separately).

The processors of the computer 800, the computing device 900, and the computing device 1000 may be any programmable microprocessor, microcomputer or multiple-processor chip or chips that can be configured by software instructions (applications) to perform a variety of functions, including the functions of the various embodiments described below. In some mobile devices, multiple processors may be provided, such as one processor within an SoC 304 dedicated to wireless communication functions and one processor within an SoC 302 dedicated to running other applications. Software applications may be stored in memory 320, 1016 before they are accessed and loaded into the processor. The processors may include internal memory sufficient to store the application software instructions.

Implementation examples are described in the following paragraphs. While some of the following implementation examples are described in terms of example methods that may be performed in a computing device by a host controller, further example implementations may include: a computing device including a UFS device controller and a host controller configured to perform the methods of the following implementation examples; a computing device including means for performing functions of the following implementation examples, a UFS device controller and a host controller suitable for use in a computing device, in which the UFS device controller and the host controller each includes a processor configured to perform the methods of the following implementation examples; and a non-transitory, processor-readable memory having stored thereon processor-executable instructions configured to cause a UFS device controller and a host controller in a computing device configured to perform the methods of the following implementation examples.

Example 1. A method for writing data to a flash storage device including a plurality of logical units of memory, including: receiving, by the flash storage device, a command identifying a logical unit among the plurality of logical units to store data and data for storage in the identified logical unit; obtaining information indicating a memory write type for the identified logical unit; and writing the data to either a shared write booster buffer before writing to the identified logical unit of device storage or directly to the identified logical unit of device storage based on the obtained memory write type.

Example 2. The method of example 1, wherein writing the data either to a shared write booster buffer before writing to the identified logical unit of device storage or directly to the identified logical unit of device storage based on the obtained memory write type includes: writing the data to the shared write booster buffer before writing to the identified logical unit of device storage, if the obtained memory write type indicates write booster buffer usage is enabled for the identified logical unit; and writing the data to the identified logical unit of device storage by bypassing the shared write booster buffer, if the obtained memory write type indicates write booster buffer usage is disabled for the identified logical unit.

Example 3. The method of any of the examples 1-2, further including: storing in a memory table of the flash storage device a value indicating the memory write type for each of the plurality of logical units, wherein obtaining information indicating the memory write type for the identified logical unit comprises obtaining, from the memory table, the value indicating the memory write type corresponding to the identified logical unit.

Example 4. The method of any of the examples 1-3, further including: wherein storing in the memory table of the flash storage device a value indicating the memory write type for each of the plurality of logical units comprises provisioning the memory table at boot of the flash storage device.

Example 5. The method of any of the examples 1-4, further including receiving by the flash storage device a command that changes the value indicating the memory write type corresponding to one or more of the plurality of logical units.

Example 6. The method of any of the examples 1-5, wherein obtaining information indicating the memory write type for the identified logical unit includes obtaining the information indicating the memory write type from the command identifying the logical unit to store the data.

Example 7. The method of any of the examples 1-6, wherein the information in the command indicating the memory write type includes a bit in a command Universal Flash Storage (UFS) Protocol Information Unit (UPIU) in which the bit indicates that subsequent data should be written to the shared write booster buffer before writing to the identified logical unit of device storage or written directly to the identified logical unit of device storage.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for writing data to a flash storage device including a plurality of logical units of memory, comprising:
receiving, by the flash storage device, a command identifying a logical unit among the plurality of logical units to store data and data for storage in the identified logical unit;
obtaining, by the flash storage device, information indicating a memory write type for the identified logical unit; and
writing, by the flash storage device, the data either to a shared write booster buffer before writing to the identified logical unit of device storage or directly to the identified logical unit of device storage of based on the obtained memory write type.

2. The method of claim 1, wherein writing the data either to a shared write booster buffer before writing to the identified logical unit of device storage or directly to the identified logical unit of device storage based on the obtained memory write type comprises:
writing the data to the shared write booster buffer before writing to the identified logical unit of device storage, if the obtained memory write type indicates write booster buffer usage is enabled for the identified logical unit; and
writing the data to the identified logical unit of device storage by bypassing the shared write booster buffer, if the obtained memory write type indicates write booster buffer usage is disabled for the identified logical unit.

3. The method of claim 1, further comprising:
storing in a memory table of the flash storage device a value indicating the memory write type for each of the plurality of logical units,
wherein obtaining information indicating the memory write type for the identified logical unit comprises obtaining, from the memory table, the value indicating the memory write type corresponding to the identified logical unit.

4. The method of claim 3, wherein storing in the memory table of the flash storage device a value indicating the memory write type for each of the plurality of logical units comprises provisioning the memory table at boot of the flash storage device.

5. The method of claim 3, further comprising receiving by the flash storage device a command that changes the value indicating the memory write type corresponding to one or more of the plurality of logical units.

6. The method of claim 1, wherein obtaining information indicating the memory write type for the identified logical unit comprises obtaining the information indicating the memory write type from the command identifying the logical unit to store the data.

7. The method of claim 6, wherein the information in the command indicating the memory write type comprises a bit in a command Universal Flash Storage (UFS) Protocol Information Unit (UPIU) in which the bit indicates that subsequent data should be written to the shared write booster buffer before writing to the identified logical unit of device storage or written directly to the identified logical unit of device storage.

8. A flash storage device, comprising:
a plurality of logical units of memory;
a shared write booster buffer; and
a device controller coupled to the plurality of logical units of memory and the shared write booster buffer, wherein the device controller is configured to perform operations comprising:
receiving, by the flash storage device, a command identifying a logical unit among the plurality of logical units to store data and data for storage in the identified logical unit;
obtaining information indicating a memory write type for the identified logical unit; and
writing the data either to a shared write booster buffer before writing to the identified logical unit of device storage or directly to the identified logical unit of device storage based on the obtained memory write type.

9. The flash storage device of claim 8, wherein the device controller is configured to perform operations such that writing the data either to a shared write booster buffer before writing to the identified logical unit of device storage or directly to the identified logical unit of device storage based on the obtained memory write type comprises:
writing the data to the shared write booster buffer before writing to the identified logical unit of device storage, if the obtained memory write type indicates write booster buffer usage is enabled for the identified logical unit; and
writing the data to the identified logical unit of device storage by bypassing the shared write booster buffer, if the obtained memory write type indicates write booster buffer usage is disabled for the identified logical unit.

10. The flash storage device of claim 8, wherein the device controller is configured to perform operations further comprising:
storing in a memory table of the flash storage device a value indicating the memory write type for each of the plurality of logical units,
wherein obtaining information indicating the memory write type for the identified logical unit comprises obtaining, from the memory table, the value indicating the memory write type corresponding to the identified logical unit.

11. The flash storage device of claim 10, wherein the device controller is configured to perform operations such that storing in the memory table of the flash storage device a value indicating the memory write type for each of the plurality of logical units comprises provisioning the memory table at boot of the flash storage device.

12. The flash storage device of claim 8, wherein the device controller is configured to perform operations further comprising receiving by the flash storage device a command that changes the value indicating the memory write type corresponding to one or more of the plurality of logical units.

13. The flash storage device of claim 8, wherein the device controller is configured to perform operations such that obtaining information indicating the memory write type for the identified logical unit comprises obtaining the information indicating the memory write type from the command identifying the logical unit to store the data.

14. The flash storage device of claim 11, wherein the information in the command indicating the memory write type comprises a bit in a command Universal Flash Storage (UFS) Protocol Information Unit (UPIU) in which the bit indicates that subsequent data should be written to the shared write booster buffer before writing to the identified logical unit of device storage or written directly to the identified logical unit of device storage.

15. A flash storage device, comprising:
means for receiving a command identifying a logical unit among a plurality of logical units to store data and data for storage in the identified logical unit;
means for obtaining information indicating a memory write type for the identified logical unit; and
means for writing the data either to a shared write booster buffer before writing to the identified logical unit of device storage or directly to device storage of the identified logical unit based on the obtained memory write type.

16. The flash storage device of claim 15, wherein means for writing the data either to a shared write booster buffer before writing to the identified logical unit of device storage or directly to the identified logical unit of device storage based on the obtained memory write type comprises:
means for writing the data to the shared write booster buffer before writing to the identified logical unit of device storage, if the obtained memory write type indicates write booster buffer usage is enabled for the identified logical unit; and
means for writing the data to the identified logical unit of device storage by bypassing the shared write booster buffer, if the obtained memory write type indicates write booster buffer usage is disabled for the identified logical unit.

17. The flash storage device of claim 15, further comprising:
means for storing in a memory table of the flash storage device a value indicating the memory write type for each of the plurality of logical units,
wherein means for obtaining information indicating the memory write type for the identified logical unit comprises means for obtaining, from the memory table, the value indicating the memory write type corresponding to the identified logical unit.

18. The flash storage device of claim 17, wherein means for storing in the memory table of the flash storage device a value indicating the memory write type for each of the plurality of logical units comprises means for provisioning the memory table at boot of the flash storage device.

19. The flash storage device of claim 17, further comprising means for receiving by the flash storage device a command that changes the value indicating the memory write type corresponding to one or more of the plurality of logical units.

20. The flash storage device of claim 15, wherein means for obtaining information indicating the memory write type for the identified logical unit comprises means for obtaining the information indicating the memory write type from the command identifying the logical unit to store the data.

21. The flash storage device of claim 20, wherein the information in the command indicating the memory write type comprises a bit in a command Universal Flash Storage (UFS) Protocol Information Unit (UPIU) in which the bit indicates that subsequent data should be written to the shared write booster buffer before writing to the identified logical unit of device storage or written directly to the identified logical unit of device storage.

22. A non-transitory processor-readable medium having stored thereon processor-executable instructions configured to cause a device controller of a flash storage device to perform operations comprising:
receiving a command identifying a logical unit among a plurality of logical units to store data and data for storage in the identified logical unit;
obtaining information indicating a memory write type for the identified logical unit; and
writing the data either to a shared write booster buffer before writing to the identified logical unit of device storage or directly to the identified logical unit of device storage based on the obtained memory write type.

23. The non-transitory processor-readable medium of claim 22, wherein the stored processor-executable instructions are configured to cause a device controller of a flash storage device to perform operations such that writing the data either to a shared write booster buffer before writing to the identified logical unit of device storage or directly to the identified logical unit of device storage based on the obtained memory write type comprises:
writing the data to the shared write booster buffer before writing to the identified logical unit of device storage, if the obtained memory write type indicates write booster buffer usage is enabled for the identified logical unit; and
writing the data to the identified logical unit of device storage by bypassing the shared write booster buffer, if the obtained memory write type indicates write booster buffer usage is disabled for the identified logical unit.

24. The non-transitory processor-readable medium of claim 22, wherein:
the stored processor-executable instructions are configured to cause a device controller of a flash storage device to perform operations further comprising storing in a memory table of the flash storage device a value indicating the memory write type for each of the plurality of logical units; and
the stored processor-executable instructions are configured to cause a device controller of a flash storage device to perform operations such that obtaining information indicating the memory write type for the identified logical unit comprises obtaining, from the memory table, the value indicating the memory write type corresponding to the identified logical unit.

25. The non-transitory processor-readable medium of claim 24, wherein the stored processor-executable instructions are configured to cause a device controller of a flash storage device to perform operations such that storing in the memory table of the flash storage device a value indicating the memory write type for each of the plurality of logical units comprises provisioning the memory table at boot of the flash storage device.

26. The non-transitory processor-readable medium of claim 24, wherein the stored processor-executable instructions are configured to cause a device controller of a flash storage device to perform operations further comprising receiving by the flash storage device a command that changes the value indicating the memory write type corresponding to one or more of the plurality of logical units.

27. The non-transitory processor-readable medium of claim 22, wherein the stored processor-executable instructions are configured to cause a device controller of a flash storage device to perform operations such that obtaining information indicating the memory write type for the identified logical unit comprises obtaining the information indicating the memory write type from the command identifying the logical unit to store the data.

28. The non-transitory processor-readable medium of claim 27, wherein the information in the command indicating the memory write type comprises a bit in a command Universal Flash Storage (UFS) Protocol Information Unit (UPIU) in which the bit indicates that subsequent data should be written to the shared write booster buffer before writing to the identified logical unit of device storage or written directly to the identified logical unit of device storage.
